(19) United States
(12) Patent Application Publication
(10) Pub. No.: US 2010/0103265 A1
(43) Pub. Date: Apr. 29, 2010

(54) IMAGE RECORDING METHODS AND SYSTEMS FOR RECORDING A SCENE-CAPTURING IMAGE WHICH CAPTURES ROAD SCENES AROUND A CAR, AND MACHINE READABLE MEDIUM THEREOF

(75) Inventors: Chien-Chih Yu, Taipei Hsien (TW); Chih-Feng Yeh, Taipei Hsien (TW)

Correspondence Address: QUINTERO LAW OFFICE, PC, 615 Hampton Dr, Suite A202, Venice, CA, 90291, US

(73) Assignee: WISTRON CORP., Taipei Hsien (TW)

(21) Appl. No.: 12/573,074

(22) Filed: Oct. 2, 2009

(30) Foreign Application Priority Data
Oct. 28, 2008 (TW) TW97141344

(51) Int. Cl. H04N 7/18

(52) U.S. Cl. 348/148; 348/E07.085

(57) ABSTRACT

An image recording method for use in an electronic device configured on a car for recording a scene-capturing image which captures road scenes around the car is disclosed. The method comprises the following steps. First, a positioning signal is received. The positioning signal is decoded to obtain determination data. It is determined whether a predetermined condition is satisfied based on the determination data. The recording of the scene-capturing image is continued when the predetermined condition is satisfied and the recording of the scene-capturing image is stopped when the predetermined condition has not been satisfied for a predetermined time period.

### CROSS REFERENCE TO RELATED APPLICATIONS

This Application claims priority of Taiwan Patent Application No. 097141344, filed on Oct. 28, 2008, the entirety of which is incorporated by reference herein.

### BACKGROUND OF THE INVENTION

1. Field of the Invention

The disclosure relates generally to image recording systems and related image recording methods, and, more particularly to image recording systems and related image recording methods that are capable of automatically and immediately stopping the recording of a scene-capturing image which captures road scenes around a car.

2. Description of the Related Art

Image recording systems are capable of recording scene-capturing images which capture road scenes in front of a car, such as road traffic. Thus, when accidents occur, the recorded scene-capturing images may be used as reference images to analyze or verify the cause of the accidents. However, due to limited memory capacity of conventional image recording systems, the length of time for recording scene-capturing images is normally fixed. Additionally, conventional image recording systems normally operate by cyclically rewriting over previous recordings. Thus, when an accident occurs, conventional image recording systems do not stop the recording of the scene-capturing image immediately, such that images of the accident may be overwritten and lost.

It is therefore important, to develop an image recording systems that may automatically and immediately stop recording of scene-capturing images during an accident, so that the images are not overwritten and lost and may be used to verify the cause of the accident.

### BRIEF SUMMARY OF THE INVENTION

An image recording system and related image recording method for recording a scene-capturing image are provided to automatically and immediately stop recording of scene-capturing images.

In an embodiment of an image recording method for use in an electronic device configured on a car for recording a scene-capturing image which captures road scenes around the car, a positioning signal is first received. The positioning signal is then decoded to obtain determination data. It is determined whether a predetermined condition is satisfied based on the determination data. When the predetermined condition is satisfied, recording of the scene-capturing image is continued. When the predetermined condition has not been satisfied for a predetermined time period, the recording of the scene-capturing image is stopped.

An embodiment of an image recording system for recording a scene-capturing image which captures road scenes around a car comprises a signal receiving unit, an image capture unit and a control unit. The signal receiving unit receives a positioning signal. The image capture unit captures/records a scene-capturing image. The control unit is coupled to the signal receiving unit and the image capture unit for obtaining determination data according to the positioning signal and determines whether a predetermined condition is satisfied based on the determination data. Wherein, the control unit directs the image capture unit to continually record the scene-capturing image when the predetermined condition is satisfied and the control unit directs the image capture unit to stop the recording of the scene-capturing image when the predetermined condition has not been satisfied for a predetermined time period.

Image recording methods and systems for an electronic device configured on a car for recording a scene-capturing image which captures road scenes around the car may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an image recording system for recording a scene-capturing image of the invention;

FIG. 2 is a flowchart of an embodiment of an image recording method for use in an electronic device configured on a car for recording a scene-capturing image of the invention; and

FIG. 3 is a flowchart of another embodiment of an image recording method for recording a scene-capturing image of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

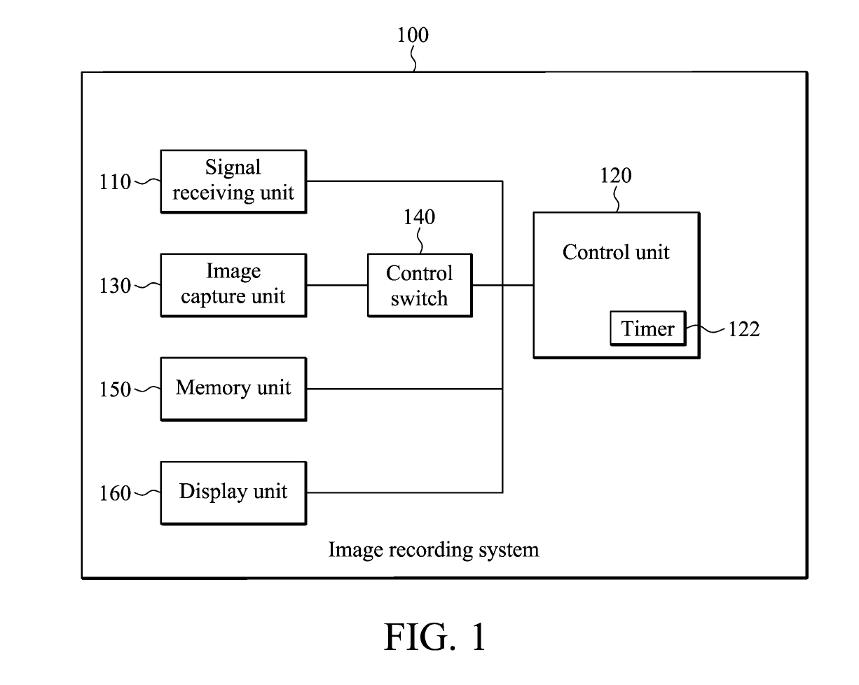

FIG. 1 is a schematic diagram illustrating an embodiment of an image recording system for recording a scene-capturing image of the invention, wherein the image recording system may be implemented in an electronic device (not shown) configured on a fix position of a car. As shown in FIG. 1, the image recording system 100 at least comprises a signal receiving unit 110, a control unit 120, an image capture unit 130, a control switch 140, a memory unit 150 and a display unit 160. The signal receiving unit 110 is used for receiving satellite positioning signals, such as Global Positioning System (GPS) positioning signals. The image capture unit 130 (e.g. a video camera) captures/records a scene-capturing image which captures road scenes around the car, such as in front of and/or in back of the car. Note that the captured/recorded scene-capturing image may be a recorded scene-capturing image on a road, such as road traffic, following stoppage of the scene-capturing image, for example, due to an accident, wherein the reason for the accident may be analyzed or verified. The control unit 120 is coupled to the signal receiving unit 110 and the image capture unit 130 and controls the image capture unit 130 (the video camera) to captures/records a scene-capturing image or stop capturing/recording of the scene-capturing image through the control switch 140. The memory unit 150 has a recordable time with a fixed time length for storing the scene-capturing image recorded by the image capture unit 130.

When a car is moving, the control unit 120 obtains determination data according to the positioning signal received by the signal receiving unit 110 for determining whether a predetermined condition is satisfied. For example, the control unit 120 may determine whether the predetermined condition is satisfied by determining whether the position of the electronic device has continually changed and/or the speed of the electronic device is not zero. Because the electronic device is configured on the car, when the car is moving in a specific speed, the electronic device is also referred to as moving in the same speed. Therefore, the speed of the electronic device may be determined as same as that of the car. When the predetermined condition is satisfied, the control unit 120 directs the image capture unit 130 to continually record the scene-capturing image via the control switch 140, and when the predetermined condition has not been satisfied for a predetermined time period, the control unit 120 directs the image capture unit 130 to stop the capturing/recording of the scene-capturing image via the control switch 140.

The display unit 160 is used to display a message indicating that the recording of the scene-capturing image has stopped. The display unit may further provide a user interface (not shown) for a user to manually cancel/abort a request for stopping the recording of the scene-capturing image such that the recording of the scene-capturing image is not stopped or restarted/resumed.

The control unit 120 may further comprise a timer 122 in which the timer 122 starts a count when the predetermined condition has not been satisfied for determining whether the predetermined condition has not been satisfied for a predetermined time period.

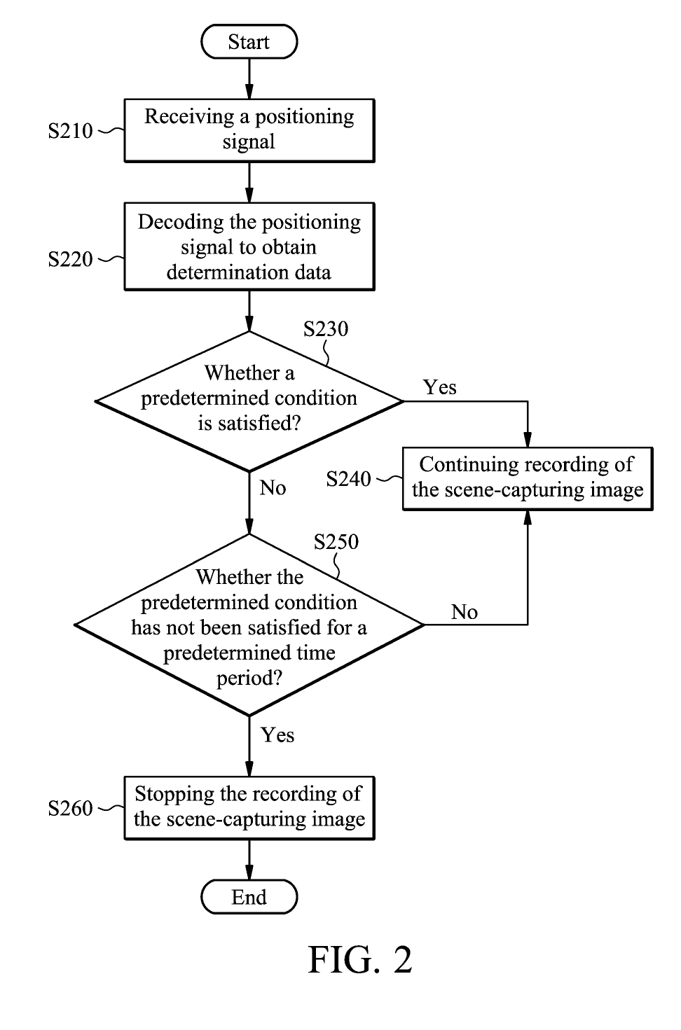

FIG. 2 is a flowchart of an embodiment of an image recording method for recording a scene-capturing image which captures road scenes around the car of the invention. The image recording method is suitable for use in an electronic device, configured on the car, that is equipped with the image recording system 100 shown in FIG. 1.

First, in step S210, a positioning signal is received. Then, in step S220, the received positioning signal is decoded to obtain determination data. The determination data may comprise information regarding current position, speed and time of the electronic device, but is not limited thereto. In step S230, it is determined whether a predetermined condition is satisfied based on the determination data. The predetermined condition may, for example, correspond to a change in position and/or speed of the electronic device, but is not limited thereto. For example, if the predetermined condition corresponds to the position of the electronic device, determination of whether the predetermined condition is satisfied is to determine whether the position of the electronic device has continually changed and the predetermined condition is determined as being satisfied when the position of the electronic device has continually changed. In contrast, if the position of the electronic device has not continually changed and is fixed in some location, the predetermined condition is determined to not be satisfied. Similarly, if the predetermined condition corresponds to the speed of the electronic device, determination of whether the predetermined condition is satisfied is to determine whether the speed of the electronic device is zero and the predetermined condition is determined as being satisfied when the speed of the electronic device is not zero. In contrast, if the speed of the electronic device is zero, the predetermined condition is determined to not be satisfied.

When the predetermined condition is satisfied, step S240 is performed and when the predetermined condition is not satisfied, step S250 is performed. In step S240, the predetermined condition is satisfied, which represents that no particular situation, such as a car accident, has occurred, thus recording of the scene-capturing image is continued. When the predetermined condition is not satisfied, in step S250, which represents that a particular situation may have occurred, step S260 is further performed to determine whether the predetermined condition has not been satisfied for a predetermined time period. Meanwhile, the timer 122 may start a count for counting a total time that the predetermined condition has not been satisfied so as to determine whether the predetermined condition has not been satisfied for a predetermined time period or not. Note that the predetermined time period may correspond to the recordable time with a fixed time length of the memory unit 150. For example, if the recordable time of the memory unit 150 is configured to be 60 minutes, the predetermined time period may be configured to 7-10 minutes.

Once the predetermined condition is satisfied within the predetermined time period (No in step S250), which represents that no particular situation, such as a car accident, has occurred, the current recording operation is determined to not have to be stopped and the recording of the scene-capturing image is continued. When the predetermined condition has not been satisfied for a time period that exceeds the predetermined time period (Yes in step S250), which represents that a particular situation has occurred, step S260 is performed to stop the recording of the scene-capturing image.

After the recording of the scene-capturing image is stopped, a recorded image that was recorded within the predetermined time period and a fragment image that was recorded from the end of the predetermined time period to a time point of stopping the recording of the scene-capturing image are utilized to generate a protection image and the protection image is further configured as a read-only image and stored in the memory unit 150.

Since the recorded scene-capturing image for when the accident occurs is configured as a protection image with a read-only attribute, it will not be rewritten by other images and thus can be safely stored, preventing the image from being lost.

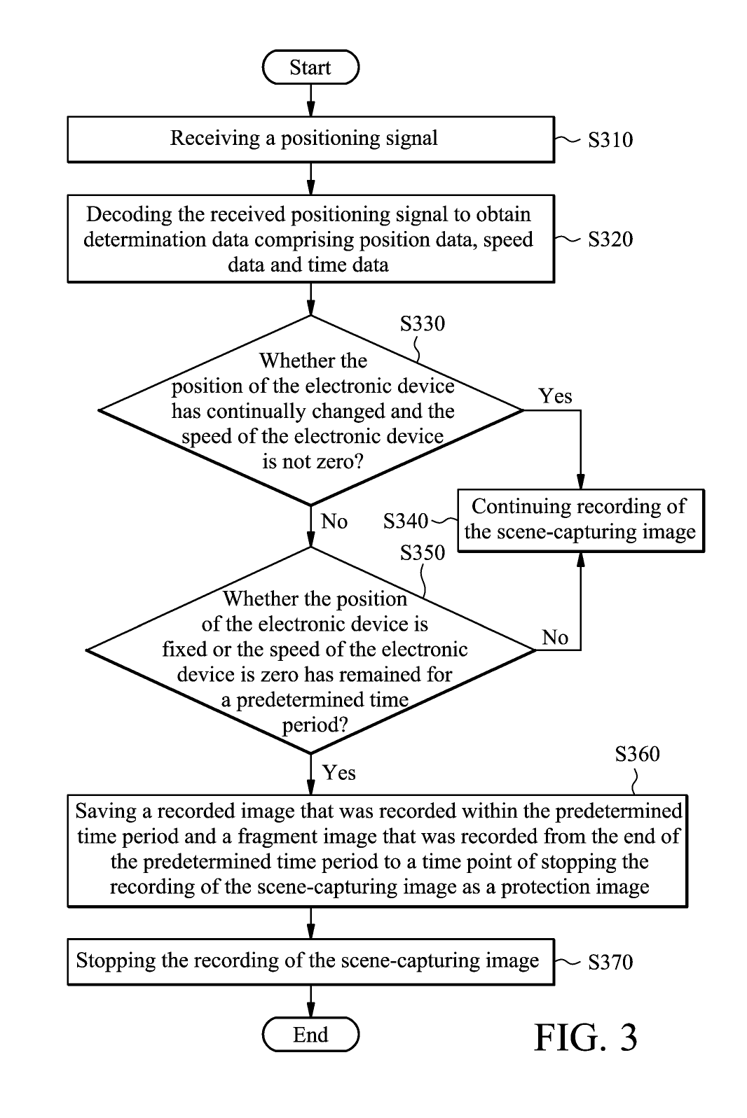

FIG. 3 is a flowchart of another embodiment of an image recording method for recording a scene-capturing image of the invention. In this embodiment, for illustration purposes, the image capture unit 130 is a video camera and the predetermined condition is defined as determining whether the position of the electronic device has continually changed and the speed of the electronic device is not zero.

As shown in FIG. 3, first, in step S310, a positioning signal is received and in step S320, the received positioning signal is decoded to obtain determination data comprising position data, speed data and time data. Thereafter, in step S330, it is determined whether the predetermined condition (i.e. the position of the electronic device has continually changed and the speed of the electronic device is not zero) is satisfied based on the determination data. When the position of the electronic device has continually continuing changed and the speed of the electronic device is not zero (Yes in step S330), which represents that no particular situation, such as an accident, has occurred, recording of the scene-capturing image is continued (step S340). In contrast, when the position of the electronic device is not continually changing (e.g. fixed) or the speed of the electronic device is zero (No in step S330), which represents that particular situation, such as an accident may have occurred, a count is started to determine whether the condition of the position of the electronic device is fixed or the speed of the electronic device is zero has remained for a predetermined time period (step S350). When determining that the condition of the position of the electronic device is fixed or the speed of the electronic device is zero for a time period shorter than the predetermined time period, which represents that the particular situation may be caused by stoppage due to factors such as a traffic light rather than factors such as a car accident, recording of the scene-capturing image is continued (step S340). When determining that the condition of the position of the electronic device is fixed or the speed of the electronic device is zero for a time period that exceeds the predetermined time period (Yes in step S350), which represents that the particular situation may be caused by a car accident, a recorded image that was recorded within the predetermined time period and a fragment image that was recorded from the end of the predetermined time period to a time point of stopping the recording of the scene-capturing image are saved as a protection image (step S360), and then the recording of the scene-capturing image is stopped (S370). For example, the recorded image within the predetermined time period when the position of the car was fixed plus a fragment image that was recorded within a time period, say 5 minutes, from the end of the predetermined time period to a time point of stopping the recording of the scene-capturing image are further stored as a protection image with read-only attributes to protect the protection image from being overwritten and lost.

In one embodiment, to prevent erroneous determination caused by situations other than the particular situations, such as an actual accident, such as a traffic jam, when the recording of the video camera has stopped, the image recording system may utilize a message (e.g. utilizing flashing of indicating lights, sounds or the likes) to inform the user that the recording of the video camera has stopped and provide a user interface for user to manually cancel/abort the request of stopping the recording of the scene-capturing image and to restart/resume the recording operation.

For example, in a cause where the predetermined condition has not been satisfied for the predetermined time period (e.g. 7 minutes) due to a traffic jam or temporarily stopped car, the image recording system may utilize a message (e.g. utilizing flashing of indicating lights, sounds or the likes) to inform the user that the recording of the video camera has stopped. Meanwhile, the user may manually cancel the request of stopping the recording of the scene-capturing image via the user interface so as to continue the recording operation.

Similarly, in the cause where the predetermined condition has not been satisfied for the predetermined time period due to bad signal quality of the received positioning signal (e.g. while traveling surrounded by tall buildings or within tunnels), the image recording system may determine that the cause for the predetermined condition not being satisfied for the predetermined time period is due to bad signal quality. Meanwhile, the image recording system may be configured to accept that the position of the signal is fixed and the speed is zero, and thus the recording of the video camera can still continue even if the signal quality is bad. If an accident has occurred during the time the signal quality of the received positioning signal is bad, the image recording system may further configure a “bad signal accumulating time” and an accident would be determined as having occurred when it is determined that an accumulated time that was accumulated by the time the received signal quality of the positioning signal was bad exceeded the configured bad signal accumulating time. In this case, the image recording system directs the video camera to stop the recording operation in which a recorded image that was recorded within the bad signal accumulating time period and a fragment image that was recorded from the end of the bad signal accumulating time period to a time point of stopping the recording of the scene-capturing image are utilized to generate a protection image. For example, if the “bad signal accumulating time” is defined to be 10 minutes, then when an accident, for example, has occurred for more than 10 minutes of the time the signal quality of the received positioning signal was bad, the image recoding system may inform the video camera to stop the recording operation and store 10 minutes plus an extra 5 minutes of scene-capturing images as a protection image. For particular situations where the time the signal quality of the received positioning signal is bad for more than 10 minutes and no accident has occurred, the user may manually cancel the request of stopping the recording operation to continue the recording operation according to the message issued by the image recording system.

In summary, according to the image recording system and related image recording method of the invention, whether an accident, for example, has occurred, can be determined by the positioning signal received by the signal receiving unit. Additionally, the recording of the scene-capturing image can be immediately stopped upon the time the accident, for example, has occurred. In addition, the recorded scene-capturing image at the time which the accident, for example, occurred, is protected to prevent it from being overwritten. Moreover, embodiments of the invention further provide solutions for various possible situations such as traffic jams or bad signals to prevent the recording operation from being erroneously stopped due to incorrect determinations, thereby improving determination accuracy for the image recording system.

Image recording systems and image recording method thereof, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An image recording method for use in an electronic device configured on a car for recording a scene-capturing image which captures road scenes around the car, comprising:
receiving a positioning signal;
decoding the positioning signal to obtain determination data;
determining whether a predetermined condition is satisfied based on the determination data;
continuing recording of the scene-capturing image when the predetermined condition is satisfied; and
stopping the recording of the scene-capturing image when the predetermined condition has not been satisfied for a predetermined time period.

2. The image recording method of claim 1, wherein the determination data comprises a positioning data, a speed data and a time data.

3. The image recording method of claim 1, wherein the predetermined condition corresponds to a change in position and/or speed of the electronic device.

4. The image recording method of claim 3, wherein the step of determining whether a predetermined condition is satisfied based on the determination data is performed by determining whether the position of the electronic device has continually changed and the speed of the electronic device is not zero.

5. The image recording method of claim 4, wherein the predetermined condition is determined as not being satisfied when the position of the electronic device is not continually changing or the speed of the electronic device is zero.

6. The image recording method of claim 1, further comprising:
when the recording of the scene-capturing image has stopped, displaying a message for indicating that the recording of the scene-capturing image has stopped.

7. The image recording method of claim 6, further comprising:
manually canceling a request for stopping the recording of the scene-capturing image via a user interface after the message for indicating that the recording of the scene-capturing image has stopped has been displayed.

8. The image recording method of claim 1, wherein the electronic device further comprises a memory unit, wherein the memory unit has a recordable time with a fixed time length and the predetermined time period corresponds to the recordable time.

9. The image recording method of claim 1, further comprising:
after stopping the recording of the scene-capturing image, generating a protection image using a recorded image that was recorded within the predetermined time period and a fragment image that was recorded from the end of the predetermined time period to a time point of stopping the recording of the scene-capturing image;
configuring the protection image as a read-only image; and
storing the read-only image in a memory unit.

10. The image recording method of claim 1, further comprising configuring a bad signal accumulating time;
utilizing a recorded image that was recorded within the bad signal accumulating time period and a fragment image that was recorded from the end of the bad signal accumulating time period to a time point of stopping the recording of the scene-capturing image to generate a protection image when determining that an accumulated time that was accumulated when the received signal quality of the positioning signal was bad exceeded the configured bad signal accumulating time;
configuring the protection image as a read-only image; and
storing the read-only image in a memory unit.

11. An image recording system for recording a scene-capturing image, comprising:
a signal receiving unit, receiving a positioning signal;
an image capture unit, capturing/recording a scene-capturing image; and
a control unit coupled to the signal receiving unit and the image capture unit, obtaining determination data according to the positioning signal and determining whether a predetermined condition is satisfied based on the determination data,
wherein the control unit directs the image capture unit to continually record the scene-capturing image when the predetermined condition is satisfied, and the control unit directs the image capture unit to stop recording of the scene-capturing image when the predetermined condition has not been satisfied for a predetermined time period.

12. The image recording system of claim 11, further comprising a memory unit, wherein the memory unit has a recordable time with a fixed time length and the predetermined time period corresponds to the recordable time.

13. The image recording system of claim 12, wherein the control unit further, after stopping the recording of the scene-capturing image, generates a protection image using a recorded image that was recorded within the predetermined time period and a fragment image that was recorded from the end of the predetermined time period to a time point of stopping the recording of the scene-capturing image, configures the protection image as a read-only image and stores the read-only image to the memory unit.

14. The image recording system of claim 11, further comprising a display unit for displaying a message indicating that the recording of the scene-capturing image has been stopped when the recording of the scene-capturing image has stopped.

15. The image recording system of claim 14, wherein the display unit further provides a user interface for a user to manually cancel a request for stopping the recording of the scene-capturing image.

16. The image recording system of claim 11, wherein the control unit further comprises a timer for determining whether the predetermined condition has been satisfied for the predetermined time period, and the timer starts counting when the predetermined condition has not been satisfied.

17. The image recording system of claim 11, wherein the determination data comprises a position data, a speed data and a time data.

18. The image recording system of claim 11, wherein the predetermined condition corresponds to a change in position and/or speed of the electronic device.

19. The image recording system of claim 18, wherein the control unit determines whether the predetermined condition is satisfied by determining whether the position of the electronic device has continually changed and the speed of the electronic device is not zero, and determines that the predetermined condition has not been satisfied when the position of the electronic device is not continually changing or the speed of the electronic device is zero.

20. A machine-readable storage medium comprising a computer program, which, when executed, causes a device configured on a car to perform an image recording method for recording a scene-capturing image which captures road scenes around the car, and the method comprising:
acquiring a positioning signal;
decoding the positioning signal to obtain determination data;
determining whether a predetermined condition is satisfied based on the determination data;
continuing recording of the scene-capturing image when the predetermined condition is satisfied; and
stopping the recording of the scene-capturing image when the predetermined condition has not been satisfied for a predetermined time period.
